(19) United States
(12) Patent Application Publication
(10) Pub. No.: US 2016/0023631 A1
(43) Pub. Date: Jan. 28, 2016

(54) PEN WITH SEAT BELT CUTTER

(71) Applicant: TAYLOR BRANDS, LLC, Kingsport, TN (US)

(72) Inventor: Jiun-Yu Chu, New Taipei City (TW)

(21) Appl. No.: 14/506,926

(22) Filed: Oct. 6, 2014

Related U.S. Application Data
(63) Continuation-in-part of application No. 29/497,365, filed on Jul. 23, 2014.

(51) Int. Cl. B60R 22/32; B43K 29/18

(52) U.S. Cl. CPC B60R 22/32; B43K 29/18; B60R 2022/328

(57) ABSTRACT

A combination writing instrument and seat belt cutter, includes a barrel and a writing implement incorporated into the barrel, a cap, and a seat belt located on the cap. The cap has a longitudinal axis, a closure end, and opposite an open end that is installable onto the barrel. The cap includes a notch defined thereon having an apex oriented parallel to the longitudinal axis of the cap and a slot defined along a lower portion of the notch parallel to the longitudinal axis of the cap. The seat belt cutter is located within the slot and includes a blade portion thereof spanning the notch.

### CROSS-REFERENCE TO RELATED APPLICATION

This application is a continuation-in-part of U.S. Design Patent Application No. 29/497,365, filed Jul. 23, 2014, entitled Pen With Seat Belt Cutter, and incorporated by reference herein in its entirety.

### FIELD

The present disclosure relates to a combination writing instrument and seat belt cutter. More particularly, the disclosure relates to a pen having a seat belt cutter integrated into the cap of the pen.

### BACKGROUND

It is desirable in an emergency to have devices at your disposal that can be utilized in an emergency situation. However, carrying equipment suitable only for an emergency situation can be costly and take up space. Accordingly, what is desired is a way to incorporate emergency equipment into daily use devices without compromising the daily use device or the aesthetics of the daily use device.

The disclosure advantageously provides a pen having an aesthetically pleasing appearance and also incorporating a seat belt cutter in a manner that does not compromise the use of the pen as a pen.

### SUMMARY

The disclosure relates to a combination writing instrument and seat belt cutter.

In one aspect, the combination writing instrument and seat belt cutter includes a barrel and a writing implement incorporated into the barrel; and a cap having a longitudinal axis, a closure end, and opposite an open end that is installable onto the barrel.

The cap also includes a notch defined thereon having an apex oriented parallel to the longitudinal axis of the cap and a slot defined along a lower portion of the notch parallel to the longitudinal axis of the cap. A seat belt cutter is located within the slot and includes a blade portion thereof spanning the notch.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a perspective view of a pen with seat belt cutter according to the disclosure.

FIGS. 2-4 are further views of the pen of FIG. 1.

FIG. 5 is a partially exploded perspective view of the pen of FIG. 1 showing the cap removed from the barrel.

FIG. 6 is an exploded view of the cap.

FIG. 7 is a detailed view of the seat belt cutter portion of the pen of FIG. 1.

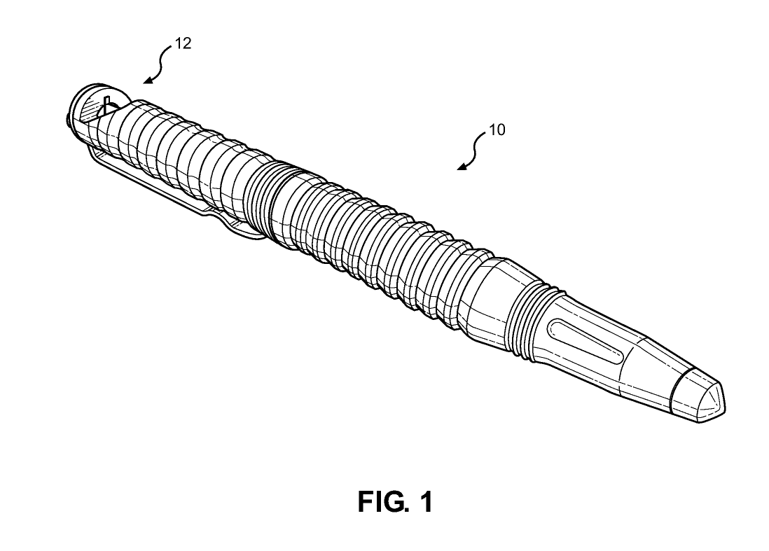

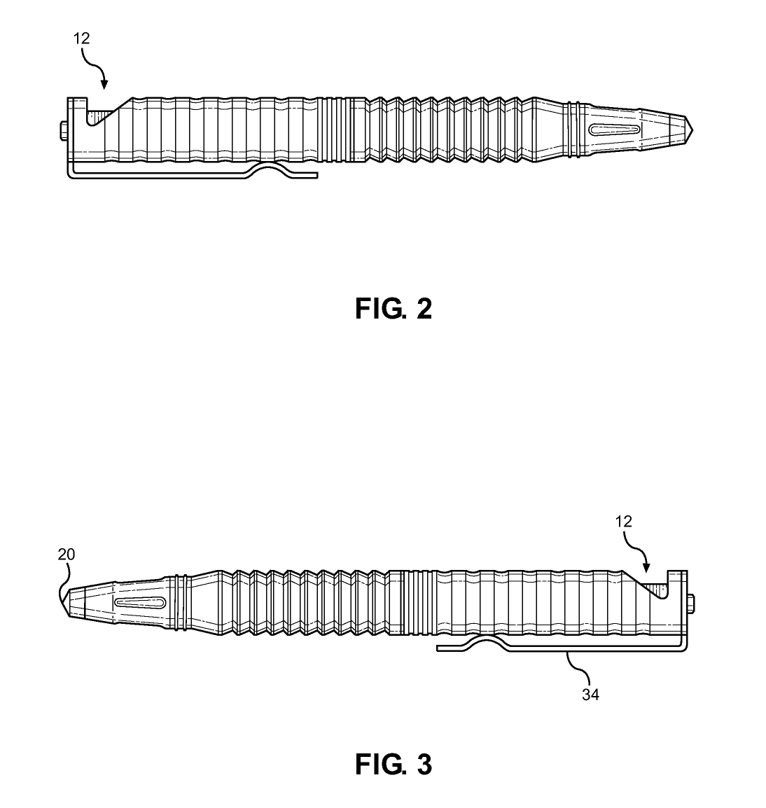

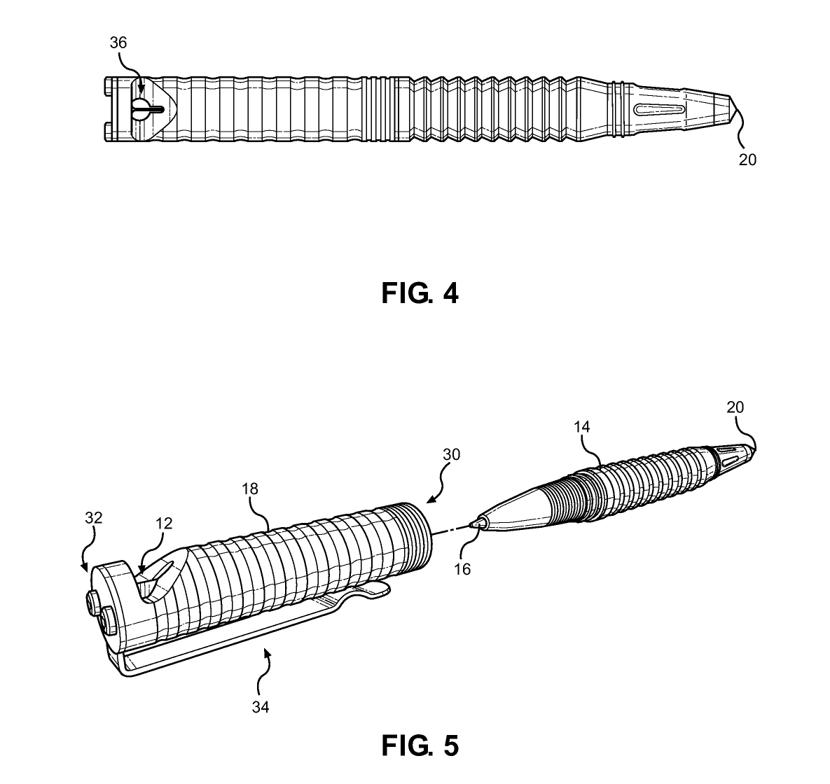

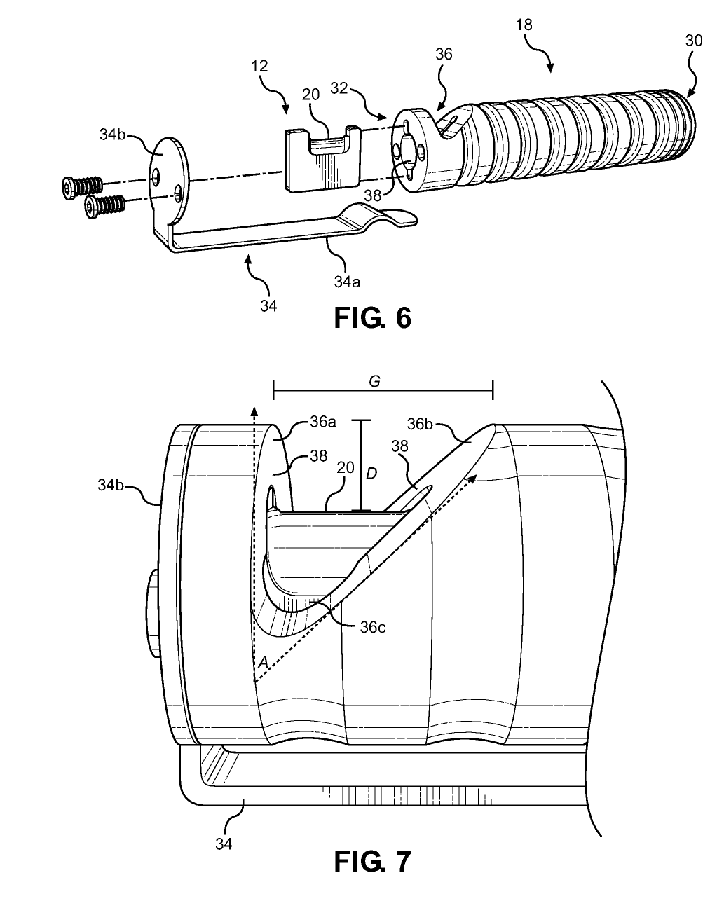

### DETAILED DESCRIPTION

With reference to the drawings, there is shown a writing instrument, such as a pen 10 including a seat belt cutter 12 according to the disclosure. The external appearance of the pen 10 is configured to be aesthetically pleasing and includes various external ornamental features.

The pen 10 includes a barrel 14 housing a writing implement such as an ink cartridge 16, and a cap 18 installable onto the barrel 14 to cover the exposed end of the ink cartridge 16.

The seat belt cutter 12 is provided as by a rectangular sheet of metal or the like having an edge surface thereof tapered or beveled to provide a blade 20. The blade 20 is not sharp so as to be able to cut a finger or the like exposed thereto as by gentle touching. However, the blade 20 is of relatively narrow width and strong so as to be suitable for cutting webbing material and heavy fabrics when pressed against with force. Thus, the blade 20 is configured to be suitable for use as an emergency tool that can be used to cut a seat belt.

The barrel 14 is preferably made of anodized aluminum and includes an exposed end opposite the exposed writing end of the ink cartridge configured to have an aesthetically pleasing appearance that also provides a point 20 suitable for breaking glass. The ink cartridge 16 may be a conventional ink cartridge, such as commonly used for ball point pens. Likewise, it will be understood that the pen 10 may be configured to include a mechanical pencil cartridge or other the like to provide a writing implement.

The cap 18 is configured as a cylinder having an open end 30 opposite a closure end 32. A pocket clip 34 is attached to the cap 18 to clip onto a shirt pocket and to also assist in securement of the seat belt cutter 12. The clip 34 is substantially L-shaped and includes a leg 34a that extends generally parallel to the cap 18 when installed and a head 34b shaped to fit over the closure end 32 of the cap 18. The head 34b includes apertures for passage of fasteners such as screws for passage into corresponding threaded apertures of the closure end 32 of the cap for securement of the cap 34b of the clip 34 to the cap 18.

The cap 18 is configured to include an angled or beveled notch 36 having a vertical sidewall 36a and an angled sidewall 36b. The notch 36 is configured to cooperate with the cutter 12 to have an aesthetically pleasing appearance and to also provide desired characteristics. An angle A defined between the sidewalls 36a and 36b desirably ranges from about 45 to about 55 degrees, most preferably about 50 degrees. The angle A thus serves to define a maximum gap C of the notch 36 of about 0.35 inches. The gap G is desirably sized so as to be large enough permit access of an edge of a seatbelt but small enough so as inhibit pressing of a finger or the like into the notch 36. To further discourage inadvertent skin contact with the blade 20, the blade 20 is preferably spaced below the uppermost edge of the notch 36 a distance D of at least about inches. The sidewalk 36a and 36b extend to about half of the diameter of the cap 18 to define an apex 36c of the notch 36 that runs generally perpendicular to the length axis of the cap 18. As will be observed, the configuration enables desired function and provides an aesthetically pleasing appearance.

An opening such as a slot 38 is defined along a lower portion of the notch 36 spanning between the sidewalk 36a and 36b so as to lie parallel to the longitudinal axis of the cap 18. The slot 38 is configured for desirably positioning the seat belt cutter 12 within the notch 36 and holding the seat belt cutter 12 firmly in position. The slot 38 extends through the closure end 32 of the cap 18 for locating, the seat belt cutter 12 within the notch 36. The head 34b of the clip 34 as retained in place by fasteners serves to secure the seat belt cutter 12 within the slot 38, with the size of the slot 38 being sized to fit the seat belt cutter 12 and provide desired exposure of the blade 20.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

What is claimed:

1. A combination writing instrument and seat belt cutter, comprising:
a barrel and a writing implement incorporated into the barrel;
a cap having a longitudinal axis, a closure end, and opposite an open end that is installable onto the barrel, the cap including a notch defined thereon having an apex oriented parallel to the longitudinal axis of the cap and a slot defined along a lower portion of the notch parallel to the longitudinal axis of the cap; and
a seat belt cutter located within the slot and including a blade portion thereof spanning the notch.

2. The combination writing instrument and seat belt cutter of claim 1, wherein the notch is an angled notch having a substantially vertical sidewall and an angled sidewall defining an angle therebetween of from about 45 to about 55 degrees.

3. The combination writing instrument and seat belt cutter of claim 1, wherein the slot extends to the closure end of the cap and the combination writing instrument and seat belt cutter includes a clip having a head that is shaped to fit over the closure end of the cap to cover the slot.
